(19) United States
(12) Patent Application Publication
(10) Pub. No.: US 2008/0276808 A1
(43) Pub. Date: Nov. 13, 2008

(54) Thin film cooking devices and methods

(76) Inventors: Gerald A. Sus, Frankfort, IL (US); Manuel Calzada, Rolling Meadows, IL (US); James D. Ryndak, Barrington Hills, IL (US); Jeffrey S. Dixon, Chicago, IL (US)

Correspondence Address: RYNDAK & SURI LLP, 200 W. MADISON STREET, SUITE 2100, CHICAGO, IL, 60606, US

(21) Appl. No.: 11/800,906

(22) Filed: May 8, 2007

(51) Int. Cl. A47J 37/00

(52) U.S. Cl. 99/373; 99/386; 99/422; 99/423

(57) ABSTRACT

Improved cooking devices and methods of achieving intimate heat transfer contact between a low-friction, non-stick release sheet material and a heated platen are provided. In particular, improved intimate heat transfer contact may be achieved by providing a very thin release sheet, providing a layer of heat transfer enhancing material forming an intimate heat transfer contact interface between the release sheet and the platen, and/or providing a release sheet that is gas-permeable and liquid-impermeable. A dynamic tensioning system is also provided for mounting a release sheet to a heated platen and maintaining even, bidirectional tension on the release sheet to keep it taut against the platen. Illustrated embodiments of the invention include a clamshell grill and conveyorized contact toaster.

### FIELD OF THE INVENTION

The present invention relates to cooking devices and methods incorporating disposable, flexible, non-stick sheets and more particularly to a cooking device and method of optimizing heat transfer from a heated platen through a release sheet and to a food product to be cooked.

### BACKGROUND OF THE INVENTION

Disposable, flexible, non-stick sheets (“release sheets”) are widely used in direct-contact cooking applications to prevent food matter from sticking to a heated platen, and to facilitate cleaning by providing a disposable and replaceable cooking surface. Typically, one side of a release sheet of polytetrafluoroethylene (“PTFE”) or similar low-friction, temperature resistant polymeric material is placed in direct contact with a flat metallic heated platen, and a food product is placed directly on the opposite side of the release sheet for heating. This arrangement results in a significantly higher thermal resistance between the platen and the food to be cooked than that achieved by cooking on a bare platen. Consequently, a higher platen temperature is required to cook a food product in a given amount of time. Likewise, more time is required to cook a food product on a release sheet than on a bare platen at a given temperature of the platen. In both cases, more energy is consumed.

The overall thermal resistance between the platen and the food product to be cooked in widely used release sheet cooking devices and methods is approximated by the sum of two thermal resistances in series, namely, a contact resistance between the platen and the release sheet and a conductive resistance through the thickness of the release sheet. A significant part of the thermal resistance is attributable to poor contact between the release sheet and the platen. Poor contact results in a high thermal contact resistance, which contributes incrementally to the overall resistance.

A need therefore exists for improving the contact between a heated platen and a release sheet to reduce the energy and time consumed in direct-contact cooking applications, while retaining the benefits of the release sheet.

### BRIEF SUMMARY OF THE INVENTION

In accordance with one aspect of the present invention, a commercial method of efficiently cooking a food product includes providing a heated platen and a release sheet, applying a heat transfer enhancing material to the platen and/or the release sheet, securing the release sheet to the platen, and cooking the food product in direct contact with the release sheet. In this manner, improved intimate heat transfer contact is achieved between the release sheet and the platen, thereby providing more efficient heat transfer between the platen and the food product to be cooked.

In accordance with another aspect of the present invention, the heat transfer enhancing material comprises heat transfer grease.

In accordance with another aspect of the invention, the heat transfer enhancing material comprises an adhesive.

In accordance with another aspect of the invention, the release sheet is a dry, very thin release sheet that clings directly to the platen, forming an intimate contact heat transfer interface with the platen surface.

In accordance with another aspect of the invention, the release sheet is secured to the platen by a securing means. For example, the securing means may be clips attached at opposite ends of the release sheet. The clips may or may not be attached to tensioning means. In another example, the securing means may be a heat transfer adhesive.

In accordance with another aspect of the invention, the release sheet comprises PTFE material. In some embodiments, the PTFE material may be fiberglass sheets impregnated with PTFE.

In accordance with another aspect of the invention, the release sheet has a thickness of about 0.004 inches or less.

In accordance with another aspect of the invention, the release sheet has a thickness of about 0.001 inch or less.

In accordance with another aspect of the invention, improved intimate heat transfer contact is achieved between a release sheet and platen in a clamshell grill with hingedly connected upper and lower platens.

In accordance with another aspect of the invention, improved intimate heat transfer contact is achieved between a release sheet and a platen in a vertical conveyor toaster with a central platen.

### BRIEF DESCRIPTION OF THE SEVERAL VIEWS OF THE DRAWINGS

FIG. 1 illustrates one embodiment of a device in accordance with the present invention.

FIG. 2 illustrates the nesting of inner frame 22 within outer frame 21, while release sheet 14 is pressed between the frames. As shown, release sheet 14 folds over the top perimeter of inner frame 22.

FIG. 3 is a front sectional view along line 3-3 of FIG. 1 of a release sheet 14 secured to the upper platen 13 of a clamshell grill by a dynamic tensioning system 20.

FIG. 3A is an enlarged view of the encircled portion of FIG. 3;

FIG. 4 is a front sectional view of the upper platen 13, release sheet 14, food product H, and lower platen 12, stacked in series. The direction of heat flux from upper platen 13 to food product H is indicated by the arrow labeled Q″.

FIG. 5 is a front sectional view of the upper platen 13, heat transfer enhancing material layer 28, release sheet 14, food product H, and lower platen 12, stacked in series. The direction of heat flux from upper platen 13 to food product H is indicated by the arrow labeled Q″.

FIG. 6 is a front sectional view of a vertical conveyor toaster in accordance with the present invention, comprising a central platen 32 and a conveyor system 34 contained in a housing 42.

### DETAILED DESCRIPTION OF THE INVENTION

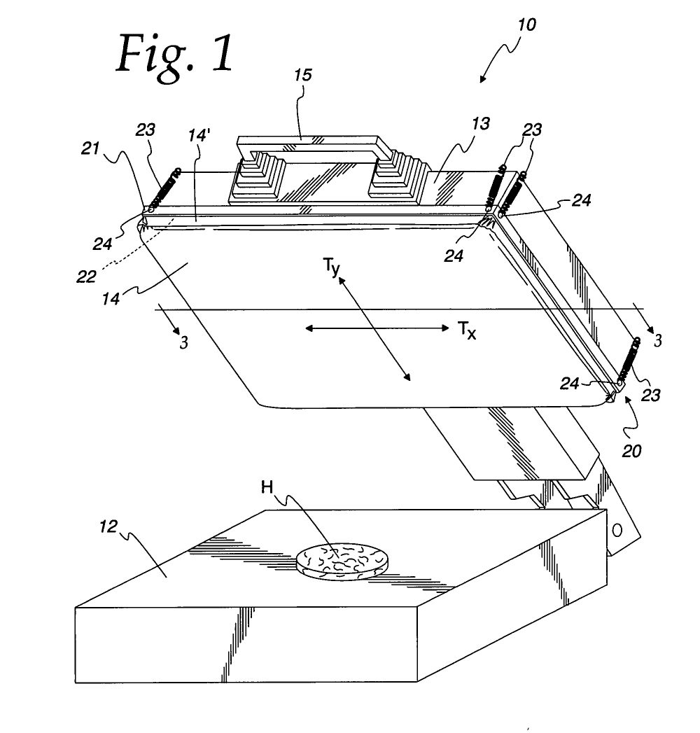

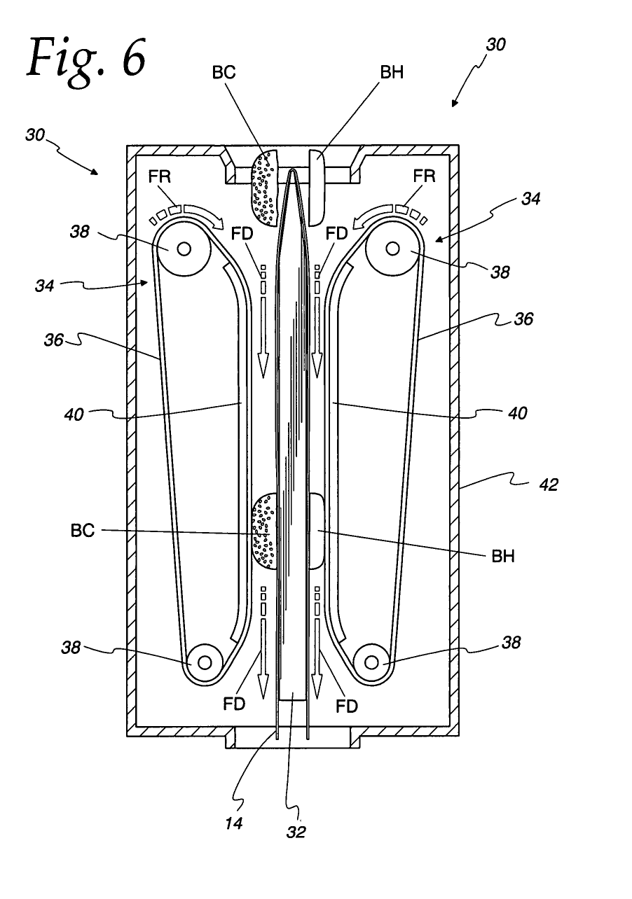

Systems for achieving enhanced intimate heat transfer contact between a release sheet and a heated platen are illustrated in FIGS. 1-6. In particular a clamshell grill in accordance with the present invention is illustrated in FIGS. 1-5, and a vertical conveyor toaster in accordance with the present invention is illustrated in FIG. 6.

Referring to FIG. 1, a clamshell grill 10 embodying the heat transfer enhancing systems of the present invention is illustrated. A food product H, such as a hamburger patty, may be placed on a heated lower platen 12 as shown, and a heated upper platen 13 having a handle 15 may be closed onto the food product H, for two-sided cooking of the food product H. Release sheet 14 prevents food product H from sticking to upper platen 13 when upper platen 13 is lifted, while a high heat transfer coefficient between food product H and upper platen 13 is maintained.

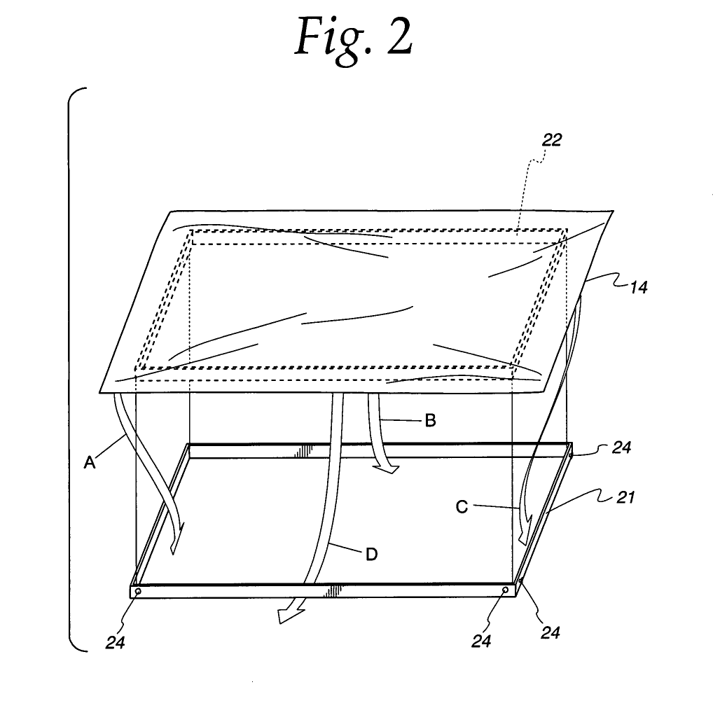

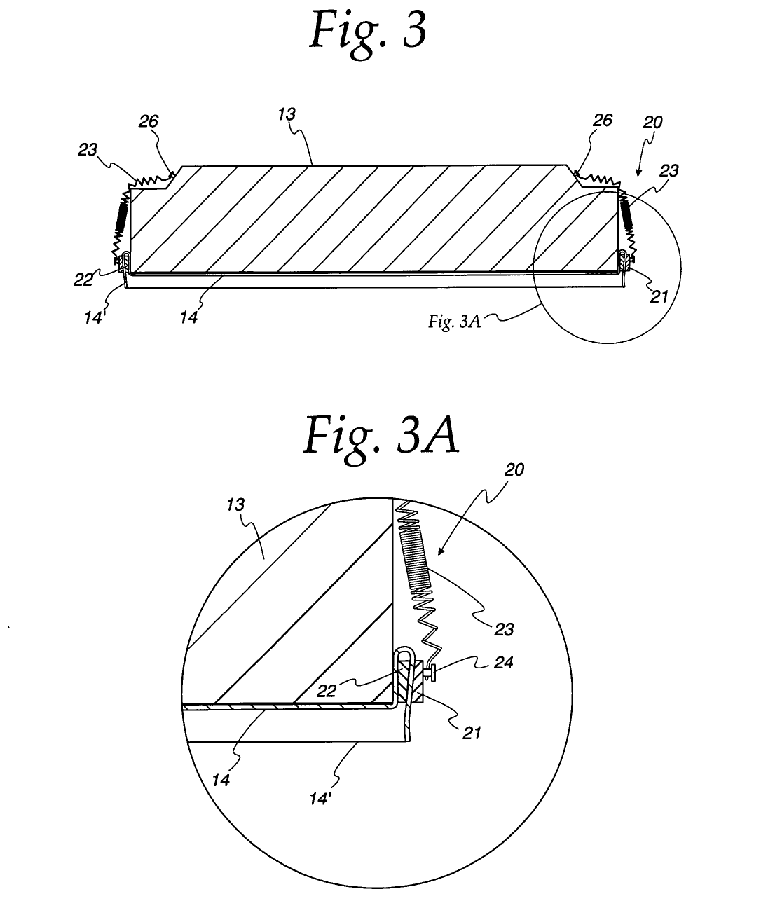

As shown in FIGS. 1-3A, release sheet 14 is retained in contact with upper platen 13 by dynamic release sheet tensioning system 20. Dynamic tensioning system 20 is composed of a tapered outer frame 21, a smaller tapered inner frame 22 nested within outer frame 21, and spring mechanisms 23, which provide tensions Tₓ and T_{y} on the release sheet in orthogonal directions. An advantage of the dynamic tensioning system 20 having nested frames and providing tensions Tₓ and T_{y} in orthogonal directions is even distribution of tension around the perimeter of the release sheet. This helps to avoid ripples or dimples in the release sheet, thereby minimizing the presence of air pockets between the platen and the release sheet. The nesting relationship between frames 21 and 22 is illustrated in FIGS. 2-3. As shown in FIG. 2, release sheet 14 is laid on top of inner frame 22 and its edges tucked under outer frame 21 as denoted by arrows A, B, C, and D. Excess peripheral portion 14′ of sheet 14 hangs downwardly as shown in FIGS. 1, 3 and 3A. FIG. 3 is a front sectional view of upper platen 13, illustrating how release sheet 14 is retained between the nested frames 21 and 22 and kept taut against the surface of upper platen 13 by spring mechanisms 23, which provide tension between pins 24 on outer frame 21 and pins 26 on the sides of upper platen 13. The springs used in spring mechanisms 23 preferably each provide about 30 to 80 pounds of constant tension, depending on the yield strength of the release sheet material. Constant tension in the spring mechanisms, the dynamic aspect of dynamic tensioning system 20, responds to any slack that develops in the sheet by pulling it taut.

Other securing assemblies may also be suitable for use in accordance with the present invention, such as an opposed pair or a plurality of spring-tensioned clips or hooks arranged about the perimeter of the release sheet. Moreover, as alternatives to the dynamic tensioning system 20, release sheet 14 may instead be retained by a heat transfer enhancing adhesive, or in the case of a very thin release sheet, by simply “clinging” to the surface of upper platen 13. For instance a static charge may be generated on the sheet prior to mounting, thereby creating a static electric cling force that holds the sheet in contact with the platen. Although not shown in the figures, a second release sheet may be similarly retained in contact with lower platen 12, by any of the foregoing or other suitable methods.

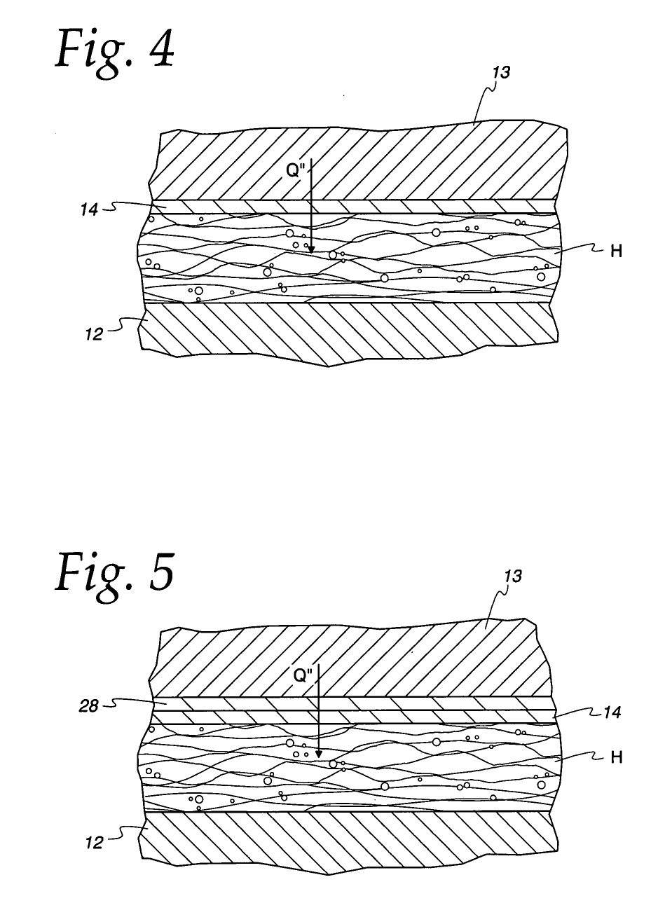

Turning to FIG. 4, a front sectional view of the upper platen 13, release sheet 14, food product H, and lower platen 12 is illustrated. Heat transfer from the upper platen 13 to the food product H is indicated by the arrow labeled Q″. As noted above, heat transfer Q″ is greatly enhanced by reducing the thermal resistance across the interface between upper platen 13 and release sheet 14. In particular, when release sheet 14 is a very thin release sheet, it is able to adhere well to upper platen 13, thereby achieving enhanced intimate contact and reducing thermal resistance. For example, in a study of a dry, 0.0015 inch thick, pure PTFE release sheet mounted on a stainless steel platen, a thermal contact resistance-times-area product of about 0.0032 hr-ft²-° F./BTU was achieved. This represented a 15% improvement over the 0.0037 hr-ft²-° F./BTU achieved using a previously known 0.0045 inch thick, PTFE-impregnated fiberglass release sheet. As a result, more efficient and better cooking of food products can be achieved, such as better sear on meat, browning of proteins and/or caramelization of carbohydrates.

Thermal contact resistance between the platen and release sheet may be calculated by measuring the total thermal resistance between the platen and the surface of a food product and subtracting the conductive resistance of the release sheet from the total value. In particular, a total thermal resistance-times-area product between a platen and a food product (R″ₜₒₜₐₗ), measured in hr-ft²-° F./BTU, may be measured by: 1) measuring the Fahrenheit temperatures at the surface of the platen and the surface of the food product in contact with the release sheet; 2) measuring the average heat flux per unit area (Q″) in BTU/hr-ft² transferred from the platen to the food product; and 3) dividing the temperature difference between the platen and the food product (ΔT) by the average heat flux per unit area, according to the following formula:

R″ₜₒₜₐₗ=ΔT/Q″

Next, the conductive resistance-times-area product of a release sheet (R″ₛₕₑₑₜ) is calculated by dividing the thickness of the release sheet in inches (tₛₕₑₑₜ) by the thermal conductivity of the release sheet material (kₛₕₑₑₜ) in BTU-in/hr-ft²-° F., as follows:

R″ₛₕₑₑₜ=tₛₕₑₑₜ/kₛₕₑₑₜ

Finally, the thermal contact resistance-times-area product between the platen and release sheet (R″_{interface}) is calculated by subtracting the conductive resistance-times-area product of the release sheet from the total resistance-times-area product, as follows:

R″_{interface}=R″ₜₒₜₐₗ−R″ₛₕₑₑₜ

Referring now to FIG. 5, an intimate contact liquid or fluid heat transfer enhancing system incorporating an interface heat transfer enhancing material is illustrated. (The term “wet” is used, for ease of reference, to indicate systems of the present invention incorporating a heat transfer enhancing material. However, the heat transfer enhancing material need not be a liquid.) As illustrated, heat flux Q″ is directed from upper platen 13, through a layer of heat transfer enhancing material 28 and release sheet 14, and into a food product H. Heat transfer enhancing material 28 may be applied directly to the platen and/or the release sheet before the release sheet is mounted to the platen. While not wishing to be bound by theory, it is believed that the fluid or liquid heat transfer material forms an improved intimate contact heat transfer interface by filling voids that would otherwise be occupied by air, thereby reducing the heat resistance due to surface imperfections and other spacing that may exist between the platen and the release sheet.

Turning to FIG. 6, a vertical conveyor-type contact toaster 30 embodying the heat transfer enhancing systems of the present invention is illustrated. As shown, release sheet 14 is draped over central platen 32, such that a bun crown BC and a bun heel BH may be toasted in direct contact with release sheet 14 on either or both sides of central platen 32. Alternatively, the release sheet 14 may be retained by a heat transfer enhancing adhesive, clips or similar securing devices, or it may “cling” to the surface of central platen 32 due to its small thickness. Release sheet 14 facilitates sliding contact with bun crowns and heels as they are conveyed in the feed direction FD by conveyors 34, while a high heat transfer coefficient between the bun crowns and heels and central platen 32 is maintained. By way of example and not limitation, conveyors 34 may be comprised of endless belts 36, rollers 38 and guide members 40. Rollers 38 provide a feed rotation FR to continuously convey endless belts 36 over guide members 40. In this manner, guide members 40 define the feed direction FD and provide pressure holding bun crowns BC and bun heels BH against the release sheet 14 and central platen 32. The central platen 32, release sheet 14, and conveyors 34 may be contained within a housing 42. In accordance with the invention, enhanced intimate heat transfer contact between central platen 32 and release sheet 14 may be achieved by using a very thin release sheet that is able to adhere closely to central platen 32 or by applying a substantially even layer of a heat transfer enhancing material to the central platen and/or the release sheet, thereby creating an improved intimate heat transfer contact interface.

Release sheets of the present invention are made of a low friction, non-stick, temperature resistant material, which is preferably a polymeric material with or without a coating, such as pure or manipulated PTFE. Very thin release sheets used in the dry system of the present invention are preferably no more than 0.002 inch thick, more preferably no more than about 0.001 inch thick, and more preferably no more than about 0.0005 inches thick, so that they may closely adhere to the platen, minimizing the presence of air pockets at the interface between the platen and release sheet. Preferably, this results in a thermal contact resistance-times-area product less than about 0.0037 hr-ft²-° F./BTU, and more preferably less than about 0.0033 hr-ft²-° F./BTU, between the platen and release sheet. More preferably, release sheets are made of a material that is additionally gas-permeable (i.e., permeable to gases including vapors) and liquid-impermeable, such as a semi-permeable dispersion-polymerized or expanded PTFE membrane well known in the art. This type of material prevents pockets of air from being trapped between a release sheet and platen, while optionally retaining a liquid heat transfer enhancing composition between a release sheet and platen, thereby achieving improved intimate heat transfer contact.

Release sheets used in the wet system need not conform as closely to the platen, and therefore may be thicker than the very thin release sheets used in the dry system, but are preferably no more than about 0.004 inches thick, and more preferably from about 0.0005 inches to about 0.002 inches thick. As a result of the heat transfer enhancing material 28 filling interface voids, a thermal contact resistance-times-area product between (i.e., across the interface between) platen 12 and release sheet 14 of preferably less than about 0.003 hr-ft²-° F./BTU, and more preferably less than about 0.002 hr-ft²-° F./BTU, may be achieved.

The heat transfer enhancing material of the present invention may be a heat transfer grease, liquid or adhesive, as described in more detail in the following paragraphs. The grease, liquid or adhesive is preferably safe for incidental contact with food; effective and safe at cooking temperatures such as 425° F. or higher, or more preferably up to about 475° F. or even higher; and in the case of liquids, capable of wetting both the platen and the release sheet. Preferably, an adhesive in accordance with the invention permits easy removal of the release sheet from the platen and is easily cleaned from the platen.

Heat transfer greases in accordance with the present invention may be, for example, silicone liquids thickened with metal oxide filler, such as Dow Corning® 340 Heat Sink Compound (“DC-340”), available from the Dow Corning Corporation. DC-340 is stable at high temperatures and has a thermal conductivity of about 4.1 BTU-in/hr-ft²-° F.

Heat transfer liquids in accordance with the present invention may be, for example, a paraffinic hydrocarbon liquid such as Duratherm FG, available from Duratherm Extended Life Liquids (“Duratherm”). According to materials available from Duratherm, Duratherm FG meets USDA requirements for incidental food contact (H1), meets the requirements of 21 C.F.R. § 178.3570, and is NSF registered. Duratherm FG is usable at temperatures up to 620° F., and has a thermal conductivity at 425° F. of 0.92 BTU-in/hr-ft²-° F.

Heat transfer adhesives in accordance with the present invention may be, for example, a silicone RTV adhesive rubber developed for heat sink applications, such as SS35 RTV Silicone (“SS35 adhesive”), available from Moreau Marketing and Sales, Inc. SS35 adhesive operates at service temperatures up to 500° F., and has a thermal conductivity at room temperature of about 2.0 BTU-in/hr-ft²-° F.

Platens of the present invention are preferably substantially flat, metallic platens of a type widely used in contact grills and toasters, such as a clamshell grill or a vertical conveyor toaster typical of the fast food industry. Typically, the platens are stainless steel.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

What is claimed is:

1. A cooking device comprising:
a) at least one platen;
b) a flexible, non-stick release sheet releasably adhered to the platen; and
c) a heat transfer enhancing material forming an intimate contact heat transfer interface between the platen and the release sheet.

2. The cooking device of claim 1, wherein the heat transfer enhancing material is selected from the group consisting of heat transfer greases, liquids and adhesives.

3. The cooking device of claim 1, wherein the release sheet has a thickness of about 0.004 inches or less.

4. The cooking device of claim 1, wherein the release sheet has a thickness of from about 0.0005 to about 0.002 inches.

5. The cooking device of claim 1, wherein the cooking device is an opposed dual platen cooking device.

6. The cooking device of claim 1, wherein the cooking device is a conveyorized cooking device comprising:
a) a housing having at least one entry opening and at least one exit opening; and
b) a conveyor system adapted to convey food products from the entry opening to the exit opening while holding the food products adjacent the release sheet.

7. The cooking device of claim 6, wherein the cooking device is a vertical conveyor toaster.

8. The cooking device of claim 6, wherein the cooking device is a vertical conveyor grill.

9. The cooking device of claim 1, having a thermal contact resistance-times-area product between the platen and release sheet of less than about 0.003 hr-ft²-° F./BTU.

10. The cooking device of claim 1, wherein the release sheet is gas-permeable and liquid-impermeable.

11. The cooking device of claim 1, having a thermal contact resistance between the platen and release sheet of less than about 0.002 hr-ft²-° F./BTU.

12. A cooking device comprising:
a) at least one platen; and
b) a flexible, non-stick, very thin release sheet releasably adhered to and conforming to the platen, so as to achieve intimate heat transfer contact with the platen,
wherein the thermal contact resistance between the platen and release sheet is less than about 0.0037 hr-ft²-° F./BTU.

13. The cooking device of claim 12, wherein the very thin release sheet has a thickness of about 0.001 inch or less.

14. The cooking device of claim 12, wherein the very thin release sheet has a thickness of about 0.0005 inches or less.

15. The cooking device of claim 12, wherein the cooking device is an opposed dual platen cooking device.

16. The cooking device of claim 12, wherein the release sheet is gas-permeable and liquid-impermeable.

17. The cooking device of claim 12, wherein the cooking device is a conveyorized cooking device comprising:
a) a housing having at least one entry opening and at least one exit opening; and
b) a conveyor system adapted to convey food products from the entry opening to the exit opening while holding the food products adjacent the release sheet.

18. The cooking device of claim 17, wherein the cooking device is a vertical conveyor toaster.

19. The cooking device of claim 17, wherein the cooking device is a vertical conveyor grill.

20. The cooking device of claim 12, having a thermal contact resistance-times-area product between the platen and release sheet less than about 0.0035 hr-ft²-° F./BTU.

21. The cooking device of claim 12, having a thermal contact resistance-times-area product between the platen and release sheet less than about 0.0033 hr-ft²-° F./BTU.

22. A method of cooking, comprising the steps of:
a) providing a cooking device comprising at least one platen;
b) providing a flexible, non-stick release sheet;
c) applying a heat transfer enhancing material to at least one of the platen or the release sheet;
d) releasably adhering the release sheet to the platen so that the heat transfer enhancing material provides an intimate contact heat transfer interface between the platen and the release sheet; and
e) heating a food product in direct contact with the release sheet;
wherein the heat transfer enhancing material is selected from the group consisting of heat transfer greases, liquids and adhesives.

23. The method of claim 22, wherein the heat transfer enhancing material is selected from the group consisting of heat transfer greases, liquids and adhesives.

24. The method of claim 22, wherein the release sheet has a thickness of about 0.004 inches or less.

25. The method of claim 22, wherein the release sheet has a thickness of from about 0.0005 inches to about 0.002 inches.

26. The method of claim 22, wherein the release sheet is gas-permeable and liquid-impermeable.

27. The method of claim 22, wherein the cooking device is an opposed dual platen cooking device.

28. The method of claim 22, further comprising the steps of:
a) providing a housing having at least one entry opening and at least one exit opening;
b) providing a conveyor system adapted to convey a food product from the entry opening to the exit opening while holding the food product in contact with the release sheet; and
c) inserting a food product into the entry opening;
whereby the food product is cooked as it is conveyed from the entry opening to the exit opening.

29. The method of claim 28, wherein the cooking device is a vertical conveyor toaster.

30. The method of claim 28, wherein the cooking device is a vertical conveyor grill.

31. The method of claim 22, wherein a thermal contact resistance-times-area product between the platen and release sheet less than about 0.003 hr-ft²-° F./BTU is achieved.

32. The method of claim 22, wherein a thermal contact resistance-times-area product between the platen and release sheet less than about 0.002 hr-ft²-° F./BTU is achieved.

33. A method of cooking, comprising the steps of:
a) providing a cooking device comprising at least one platen;
b) providing a flexible, non-stick, very thin release sheet;
c) releasably adhering the release sheet to the platen; and
d) heating a food product in direct contact with the release sheet,
whereby the release sheet conforms to the surface of the platen, providing intimate heat transfer contact between the platen and the release sheet.

34. The method of claim 33, wherein the very thin release sheet has a thickness of about 0.001 inches or less.

35. The method of claim 33, wherein the very thin release sheet has a thickness of from about 0.0005 inches to about 0.002 inches.

36. The method of claim 33, wherein the release sheet is gas-permeable and liquid-impermeable.

37. The method of claim 33, wherein the cooking device is an opposed dual platen cooking device.

38. The method of claim 33, further comprising the steps of:
a) providing a housing having at least one entry opening and at least one exit opening;
b) providing a conveyor system adapted to convey a food product from the entry opening to the exit opening while holding the food product in contact with the release sheet; and
c) inserting a food product into the entry opening;
whereby the food product is cooked as it is conveyed from the entry opening to the exit opening.

39. The method of claim 38, wherein the cooking device is a vertical conveyor toaster.

40. The method of claim 38, wherein the cooking device is a vertical conveyor grill.

41. The method of claim 33, wherein a thermal contact resistance-times-area product between the platen and release sheet less than about 0.0037 hr-ft²-° F./BTU is achieved.

42. The method of claim 33, wherein a thermal contact resistance-times-area product between the platen and release sheet less than about 0.0033 hr-ft²-° F./BTU is achieved.
